(19) United States
(12) Patent Application Publication
(10) Pub. No.: US 2003/0137076 A1
(43) Pub. Date: Jul. 24, 2003

(54) Bondable thermoplastic constructs with improved wettability

(75) Inventors: Valeria Griep Erdos, Porto Alegre (BR); Errette Bevins, III, Waynesboro, VA (US); Kuo-Shu Edward Chang, Charlotte, NC (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 10/295,567

(22) Filed: Nov. 15, 2002

Related U.S. Application Data
(60) Provisional application No. 60/335,997, filed on Nov. 15, 2001.

(51) Int. Cl. B29C 47/00; D01F 1/10

(52) U.S. Cl. 264/129; 264/211; 264/130; 524/585

(57) ABSTRACT

The present invention is directed to the combined use of a dispersant as an internal melt additive and a surfactant as an outer topical additive to impart or improve the wettability of extruded thermoplastic constructs. A dispersant is provided to, and blended with, a thermoplastic polymer which is then formed into a thermoplastic construct. A surfactant is then applied to the thermoplastic construct to impart or improve the wettability of the thermoplastic construct.

### TECHNICAL BACKGROUND

This invention relates to thermoplastic constructs and more particularly, to the combined use of a dispersant as an internal melt additive and a surfactant as an outer topical additive to impart or improve the wettability of extruded thermoplastic constructs, such constructs including continuous filaments, microfilaments, staple fibers and films, while maintaining the ability of the thermoplastic construct to be bonded by conventional means and retaining acceptable cytotoxicity levels.

### BACKGROUND OF THE INVENTION

Thermoplastics are becoming an evermore-popular material to be used in the fabrication of disposable and semi-durable goods. The ability of thermoplastics to be formed into specialized fabrics, both woven and nonwoven, and films designed to meet specific performance requirements has resulted in such thermoplastic materials being incorporated into numerous medical, hygiene, and industrial applications. Research and development are ongoing to modify these thermoplastic materials to further improve or otherwise alter the resulting performance of the thermoplastic materials in the fabricated articles.

Particular focus of this research and development has been to the addition of additives to a thermoplastic polymer base, and to thus tailor the performance of the thermoplastic resin. Advances in the modification of thermoplastic polymer performance are evident in exemplary performance additive patents directed to changes in hydrophobicity, hydrophilicity, anti-microbial activity, barrier properties, and retention or dissipation of static charge.

The wettability of a top- or coversheet of a disposable absorbent article, measured as the capability of the coversheet to quickly transfer liquid from contact with the wearer's skin and into the absorbent structure, is a critical aspect of the user-acceptance of such articles. U.S. Pat. No. 6,043,168, addresses specifically the improvement of wettability in thermoplastic constructs; however, the associated chemistries are such that they exhibit deleterious effects on the ability to bond the treated materials and/or induce increased cytotoxicity in the resulting article.

An unmet need remains for a thermoplastic additive system that improves the wettable performance of the resulting article, and yet is compatible with various fabrication bonding means and does not induce unacceptable increases in cytotoxicity.

### SUMMARY OF THE INVENTION

The present invention is directed to the combined use of a dispersant as an internal melt additive and a surfactant as an outer topical additive to impart or improve the wettability of extruded thermoplastic constructs. A dispersant is provided to, and blended with, a thermoplastic polymer in the range of about 0.1% to 1.5% weight percent. The thermoplastic/dispersant blend is then formed into a thermoplastic construct. A surfactant is then applied to the thermoplastic construct to impart or improve the wettability of the thermoplastic construct. The dispersant either has no inherent wettable performance, or is present in the thermoplastic construct at a level insufficient to directly affect wettable performance of the construct. It is believed that the dispersant acts upon, or in synergy with, the surfactant to enhance the distribution and uniformity of the surfactant coating on the thermoplastic construct.

A dispersant containing thermoplastic resin can be extruded as multiple and continuous filaments or as a film or film layer, which are in turn either immediately treated with a topical surfactant or formed, or otherwise integrated, into a product which is then treated with a topical surfactant. The continuous filaments can be directly integrated into a nonwoven fabric or included as a layer of a nonwoven composite or laminate fabric. In the alternative, the continuous filaments may be bundled and incorporated into a yarn, which in turn, can be used in part or whole as the yarns of a woven or knitted textile fabric. Dispersant containing thermoplastics can be cast as a single sheet product or extruded onto a carrier substrate, such as another film, a textile fabric, or a nonwoven fabric.

The extruded multiple and continuous filaments can be optionally imparted with a selected level of crimp, then cut into fibers of finite staple length. These thermoplastic resin staple fibers can then be subsequently used to form textile yarns or carded and integrated into nonwoven fabrics by appropriate means, as exemplified by thermobonding, adhesive bonding, and hydroentanglement technologies.

In addition to the use of a dispersant in the form of a melt additive, additional performance additives can be admixed into the thermoplastic resin. Such performance additives include those directed to modifying the performance or aesthetics of the thermoplastic polymer base. Those that convey anti-microbial activity, improvement in skin-wellness, and modification of color represent suitable performance additives. A specific embodiment of the present invention is directed to the use of a dispersant compounded with softness-improvement additives. Suitable softness improvement additives include inert organic materials such as insoluble carbonate salts and inorganic agents.

It is also within the purview of the present invention that the manufacture of homogenous or composite fabrics embodying the principles of the present invention includes the use of a blend of fibers and/or filaments having different compositions. Differing thermoplastic polymers can be compounded with the same or different dispersants, and with the same or different performance or softness improvement additives. Further, dispersant containing fibers and/or filaments may be blended with fibers and/or filaments that have not been modified by compounding with a dispersant. Unmodified fibers and/or filaments are selected from natural or synthetic composition, of homogeneous or mixed fiber length. Suitable natural fibers include, but are not limited to, cotton, wood pulp and viscose rayon. Synthetic fibers, which may be blended in whole or part, include thermoplastic and thermoset polymers. Thermoplastic polymers suitable for blending with dispersant containing thermoplastic resins include polyolefins, polyamides and polyesters. The thermoplastic polymers may be further selected from homopolymers, copolymers, conjugates and other derivatives including those thermoplastic polymers having incorporated other melt additives or surface-active agents.

Multi-component fibers and/or filaments can also be practiced whereby a first thermoplastic polymer composition containing a first dispersant is juxtaposed in relationship to a second thermoplastic polymer composition; the second thermoplastic polymer composition being a different thermoplastic polymer than the first thermoplastic polymer, but with the same or lower levels of dispersant and/or other melt additives. Multi-component fibers and/or filaments can also include the same first and second thermoplastic polymer compositions, with one or more of the dispersant additives used differing between the two compositions. Additionally, multi-component fibers and/or filaments can be practiced whereby the first thermoplastic polymer contains a dispersant and the second thermoplastic polymer contains a lower level of dispersant. The profile of the fiber or filament and the number of thermoplastic polymer compositions juxtaposed is not a limitation to the applicability of the present invention.

Advantageously, the present invention allows for the practice of conventional fabrication processes as means for forming end-use articles from the dispersant containing thermoplastic construct. As the dispersant used is present at a low level, and does not include use of organosilicon-based compounds that inhibit or interfere with adhesive and thermobonding practices, no special equipment requirements are necessary to use a dispersant containing thermoplastic construct. Further, the use of dispersant improves the performance of a subsequently applied topical surfactant, thus allowing for a corresponding decrease in the levels of surfactant used, which in turn, reduces the known cytotoxic affects, which develop form excessive surfactant dosing.

Other features and advantages of the present invention will become readily apparent from the following detailed description, the accompanying drawings, and the appended claims.

### DETAILED DESCRIPTION

While the present invention is susceptible of embodiment in various forms, hereinafter is described a presently preferred embodiment of the invention, with the understanding that the present disclosure is to be considered as an exemplification of the invention, and is not intended to limit the invention to the specific embodiment illustrated.

The wettability of thermoplastic constructs, such as continuous filaments, staple fibers, and film, can be advantageously improved by the incorporation of a suitable dispersant. The dispersant can be selected from those agents having a polar moiety, and include, but are not limited to, surfactants, soaps, and detergents. A dispersant may also be selected from suitable chaotropic agents amenable to the thermoplastic polymer.

In addition to the dispersant, additional performance additives can be admixed into the thermoplastic resin. Such performance additives include those directed to modifying the performance of the thermoplastic polymer base. Representative chemistries with anti-microbial activity include the use of quaternary ammonium salts, as disclosed in U.S. Pat. Nos. 5,300,167, 5,569,732, and 5,854,147, all herein incorporated by reference. Suitable softness-improvement additives can, optionally, be included, such as insoluble carbonate salts and inorganic agents.

Thermoplastic polymers suitable for compounding in accordance with the present invention include polyolefins, polyamides and polyesters. The thermoplastics may be further selected from homopolymers, copolymers, conjugates and other derivatives including those thermoplastic polymers having incorporated melt additives or surface-active agents.

Technologies capable of employing the dispersant containing thermoplastic resin of the present invention include those which form continuous filament nonwoven fabrics, staple fiber nonwoven fabrics, continuous filament or staple fiber woven textiles, and films.

In general, continuous filament nonwoven fabric formation involves the practice of the spunbond process. A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent web is collected upon the uppermost surface of the previously formed web. The web is then at least temporarily consolidated, usually by means involving heat and pressure, such as by thermal point bonding. Using this means, the web or layers of webs are passed between two hot metal rolls, one of which has an embossed pattern to impart and achieve the desired degree of point bonding, usually on the order of 10 to 40 percent of the overall surface area being so bonded.

A related means to the spunbond process for forming a layer of a nonwoven fabric is the melt blown process. Again, a molten polymer is extruded under pressure through orifices in a spinneret or die. High velocity air impinges upon and entrains the filaments as they exit the die. The energy of this step is such that the formed filaments are greatly reduced in diameter and are fractured so that microfibers of finite length are produced. This differs from the spunbond process whereby the continuity of the filaments is preserved. The process to form either a single layer or a multiple-layer fabric is continuous, that is, the process steps are uninterrupted from extrusion of the filaments to form the first layer until the bonded web is wound into a roll. Methods for producing these types of fabrics are described in U.S. Pat. No. 4,041,203, incorporated herein by reference

Currently, many nonwoven manufacturing lines include at least two spunbond stations and optionally one or more meltblown stations in between. This enables the continuous production of a composite fabric consisting of discrete spunbond and meltblown layers. These fabrics are commonly called SMS, referring to a spunbond-meltblown-spunbond arrangement of layers. Thermal point bonding, as previously described, is typically used to consolidate such webs.

Staple fibers used to form nonwoven fabrics begin in a bundled form as a bale of compressed fibers. In order to decompress the fibers, and render the fibers suitable for integration into a nonwoven fabric, the bale is bulk-fed into a number of fiber openers, such as a garnet, then into a card. The card further frees the fibers by the use of co-rotational and counter-rotational wire combs, then depositing the fibers into a lofty batt. The lofty batt of staple fibers can then optionally be subjected to fiber reorientation, such as by air-randomization and/or cross-lapping, depending upon the ultimate tensile properties of the resulting nonwoven fabric. The fibrous batt is integrated into a nonwoven fabric by application of suitable bonding means, including, but not limited to, use of adhesive binders, thermobonding by calender or through-air oven, and hydroentanglement.

The production of conventional textile fabrics is known to be a complex, multi-step process. The production of staple fiber yarns involves the carding of the fibers to provide feedstock for a roving machine, which twists the bundled fibers into a roving yarn. Alternately, continuous filaments are formed into bundle known as a tow, the tow then serving as a component of the roving yarn. Spinning machines blend multiple roving yarns into yams that are suitable for the weaving of cloth. A first subset of weaving yarns is transferred to a warp beam, which, in turn, contains the machine direction yarns, which will then feed into a loom. A second subset of weaving yarns supply the weft or fill yarns which are the cross direction threads in a sheet of cloth. Currently, commercial high-speed looms operate at a speed of 1000-1500 picks per minute, whereby each pick is a single yarn. The weaving process produces the final fabric at manufacturing speeds of 60 inches to 200 inches per minute.

The formation of finite thickness films from thermoplastic polymers is a well-known practice. Thermoplastic polymer films can be formed by either dispersion of a quantity of molten polymer into a mold having the dimensions of the desired end product, known as a cast film, or by continuously forcing the molten polymer through a die, known as an extruded film. Extruded thermoplastic polymer films can either be formed such that the film is cooled then wound as a completed product, or dispensed directly onto a substrate material to form a composite material having performance of both the substrate and the film layers. Examples of suitable substrate materials include other films, polymeric or metallic sheet stock, and woven or nonwoven fabrics.

The application of the extruded film directly onto a substrate material imparts the substrate material with enhanced physical properties. It is known in the art that the application of a thermoplastic polymer film having suitable flexibility and porosity onto a nonwoven fabric results in a composite material having significant barrier properties and is suitable for disposable protective garment manufacture.

Extruded films utilizing the composition of the present invention can be formed in accordance with the following representative direct extrusion film process. Blending and dosing storage comprising at least two hopper loaders, one for thermoplastic polymer chip and one for pelletized dispersant in thermoplastic carrier resin, feed into two variable speed augers. The variable speed augers transfer predetermined amounts of polymer chip and additive pellet into a mixing hopper. The mixing hopper contains a mixing propeller to further the homogeneity of the mixture. Basic volumetric systems such as that described are a minimum requirement for accurately blending the dispersant into the thermoplastic polymer. The polymer chip and additive pellet blend feeds into a multi-zone extruder. Upon mixing and extrusion from the multizone extruder, the polymer compound is conveyed via heated polymer piping through a screen changer, wherein breaker plates having different screen meshes are employed to retain solid or semi-molten polymer chips and other macroscopic debris. The mixed polymer is then fed into a melt pump, and then to a combining block. The combining block allows for multiple film layers to be extruded, the film layers being of either the same composition or fed from different systems as described above. The combining block is connected to an extrusion die, which is positioned in an overhead orientation such that molten film extrusion is deposited at a nip between a nip roll and a cast roll.

When a substrate material is to receive a film layer extrusion, a substrate material source is provided in roll form to a tension-controlled unwinder. The base layer is unwound and moves over the nip roll. The molten film extrusion from the extrusion die is deposited onto the substrate material at the nip point between the nip roll and the cast roll. The newly formed base layer and film composite is then removed from the cast roll by a stripper roll and wound onto a new roll.

Reticulated films, such as those of patent numbers U.S. Pat. Nos. 4,381,326 and 4,329,309, incorporated herein by reference, are representative of macroporous films. Such macroporous films, which are typically employed as the topsheet or facing layer of a disposable feminine hygiene product, come in direct contact with the body and benefit significantly from improved wettability as embodied by the present invention.

Manufacture of homogenous or composite fabrics embodying the principles of the present invention includes the use of a blend of fibers and/or filaments having different compositions. Differing thermoplastic polymers can be compounded with the same or different dispersants, and with the same or different performance or wettability improvement additives. Further, dispersant fibers and/or filaments may be blended with fibers and/or filaments that have not been modified by the compounding of dispersants. Unmodified fibers and/or filaments are selected from natural or synthetic composition, of homogeneous or mixed fiber length. Suitable natural fibers include, but are not limited to, cotton, wood pulp and viscose rayon. Synthetic fibers, which may be blended in whole or part, include thermoplastic and thermoset polymers. Thermoplastic polymers suitable for blending with dispersant thermoplastic resins include polyolefins, polyamides and polyesters. The thermoplastic polymers may be further selected from homopolymers; copolymers, conjugates and other derivatives including those thermoplastic polymers having incorporated melt additives or surface-active agents. Staple lengths are selected in the range of 0.25 inch to 8 inches, the range of 1 to 3 inches being preferred and the fiber denier selected in the range of 1 to 15, the range of 2 to 6 denier being preferred for general applications. The profile of the fiber is not a limitation to the applicability of the present invention.

Utilizing the above discussed thermoplastic construct technologies, combinations of different thermoplastic constructs can be practiced to yield composite materials of improved wettable performance. One or more thermoplastic constructs' can incorporate the inclusion of a dispersant, then be combined with one or more thermoplastic constructs which utilize an alternate dispersant formulation, or includes reduced levels of dispersant, or contains no dispersant in the thermoplastic polymer composition.

In forming or integrating a material, or particular end-use article, the low levels of dispersant present in the thermoplastic construct of the present invention does not interfere with the ability to bond the dispersant containing thermoplastic construct to other dispersant containing or non-dispersant containing thermoplastic constructs. Previously, attempts to improve wettability required the use of significant quantities of an organosilicon melt additive. Use of organosilicon melt additives result in a corresponding decrease in surface energy of the resulting construct, and as a result, prevents bonding of the construct to other constructs by conventional mechanical bonding. Further, the inert nature of organosilicon chemistries prevents effective cross-linking and hydrogen bonding to other constructs, thus obviating chemical bonding as a suitable adherence means.

Application of a topical surfactant to the dispersant containing thermoplastic construct can occur either after formation of the thermoplastic construct, or to the end-use article. The topical surfactant or surfactants are selected from those having a polar moiety, and are not restricted to a specific species. Presently preferred surfactants include those listed in Table 1. The mode of application of the surfactants can occur by any number of appropriate mechanisms, including, but not limited to, direct spraying and saturation in an appropriate surfactant liquor followed by removal of excess surfactant by use of mechanical compression. The dispersant containing thermoplastic construct may be treated more than one time, and on more than one side, depending upon the desired wettable performance level and processing restrictions.

Table 1

Topical Surfactants

Cirrasol PE1100

Cirrasol PP1800

Silastrol PBP26

Achovel Base N-24

Stantex S-6327

Fabrics or materials made of the aforementioned polymer compositions, have a wide variety of end use applications, including hygiene and medical articles. Personal hygiene articles, which benefit from improved wettability, include the construction of body-side liners, such as top-sheets, coversheets and facing layers, as well as, retainers or wraps used to capture and retain absorbent core component materials. Liners for sanitary articles, such as disposable diapers and feminine hygiene product body-side liners, come in direct contact with the wearer of the article, and thus improved wettability, in particular in terms enhanced fluid transfer, results in improved comfort. Medical articles, such as bandaging, once again, benefit from the improved wettability and thus improving the wearer's comfort and ability to heal when such articles are worn for the purpose of absorbing exudates.

It has also been found that the materials of the present invention also exhibit enhanced liquid transfer properties. Such properties are sufficient to recommend use of this dispersant containing/surfactant treated thermoplastic construct as a replacement for conventional wood-pulp based materials in disposable personal hygiene articles and similar fabricated devices.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A method for manufacturing a wettable thermoplastic construct, comprising;
a. providing a thermoplastic polymer base composition;
b. providing a dispersant;
c. providing a surfactant;
d. blending said dispersants into said thermoplastic polymer base composition, said dispersant being present at a level of between 0.1 and 1.5 percent by weight of the overall blend, said level of addition being insufficient to impart wettability;
e. extruding said thermoplastic blend as a thermoplastic construct; and
f. applying said surfactant to said dispersant containing thermoplastic construct, said treated thermoplastic construct exhibiting an improved wettability as compared to a thermoplastic construct consisting of said thermoplastic polymer base.

2. A method as in claim 1, wherein said thermoplastic polymer base is selected from the group consisting of polyolefins, polyesters, polyamides and the combinations thereof.

3. A method as in claim 2, wherein said polyolefin is polypropylene.

4. A method as in claim 1, wherein said thermoplastic construct is selected from the group consisting of continuous filaments, microfilaments, fibers and film.

5. A nonwoven fabric, comprising; fibers of a thermoplastic polymer composition having therein a melt additive dispersant present at a level of between 0.1 and 1.5 percent weight, said dispersant present at a level insufficient to impart wettability, and treated with a topical surfactant.

6. A nonwoven fabric as in claim 5, wherein said fibers are selected from the group consisting of continuous filaments, microfilaments, staple length fibers, and the combinations thereof.

7. A nonwoven fabric as in claim 5, wherein said nonwoven fabric 5 is used as a body-side liner for a disposable hygiene article.

8. A nonwoven fabric as in claim 5, wherein said nonwoven fabric is used as a core-wrap for a disposable hygiene article.

9. A method for manufacturing a thermoplastic construct, comprising;
a. providing a thermoplastic polymer base composition;
b. providing a dispersant;
c. providing a performance additive;
d. blending said thermoplastic polymer base, said dispersant, and said third performance additive, wherein said dispersant being present at a level of between 0.1 and 1.5 percent by weight of the overall blend, said level of dispersant addition being insufficient to impart wettability; and
e. extruding said thermoplastic blend as a thermoplastic construct, said thermoplastic construct exhibiting an improved wettability as compared to a thermoplastic construct consisting of said thermoplastic polymer base.

10. A method as in claim 9, wherein the third performance additive is a softness improvement additive.
